(19) United States
(12) Patent Application Publication
(10) Pub. No.: US 2010/0332078 A1
(43) Pub. Date: Dec. 30, 2010

(54) Method for operating a parking aid system

(76) Inventors: Michael Hering, Leonberg (DE); Torsten Reiner, Stuttgart (DE); Benno Albrecht, Kirchheim/Tech (DE)

Correspondence Address: KENYON & KENYON LLP, ONE BROADWAY, NEW YORK, NY, 10004, US

(21) Appl. No.: 12/735,055

(22) PCT Filed: Oct. 21, 2008
(86) PCT No.: PCT/EP2008/064206

§ 371 Date: Aug. 26, 2010

(30) Foreign Application Priority Data
Dec. 21, 2007 (DE) 102007062860.0
Feb. 6, 2008 (DE) 102008007667.8

(51) Int. Cl. G06F 7/00; G08G 1/16; B60Q 1/48

(52) U.S. Cl. 701/36; 340/932.2

(57) ABSTRACT

In a method for operating a parking aid system for a vehicle having a plurality of distance sensors each sensing the near range of the vehicle, and having at least one path sensor sensing a path traveled by the vehicle, the distance sensors are operable in a first mode for the parking space measurement, and the distance sensors are operable in at least one further mode in which they are used as parking aid in order to avoid collisions. The distance sensors are temporally activated using different transmit sequences in the two modes, a switchover between the different transmit sequences being implemented as a function of the movement of the vehicle.

### BACKGROUND OF THE INVENTION

1. Field of the Invention

The present invention relates to a method for operating a parking aid system for a vehicle, the parking aid system including a plurality of distance sensors sensing the near range of the vehicle at least regionally, and at least one path sensor measuring the distance traveled by the vehicle. The distance sensors may be operated in a first mode in which, for the purpose of measuring parking spaces, the length and/or width of the parking space is determined from the values of at least individual sensors, measured while passing a parking space; in addition, they may also be operated in at least one second mode, in which they are utilized as parking aid for a parking aid system for avoiding collisions in the course of the parking operation. Moreover, if appropriate, still further operating modes of the distance sensors for additional functions of this driver assistance system are able to be provided.

2. Description of Related Art

The increase in traffic density and more and more construction taking up free space are reducing the traffic space continuously, particularly in congested urban centers. Available parking space is becoming scarcer, and the search for suitable parking spaces exposes the driver to stress in addition to the constantly increasing traffic volume. Correctly estimating the exact size and position of the parking space, especially when backing into a parking space, is often associated with considerable difficulties. Many drivers are frequently unsure whether their vehicle will fit into a parking space that they have found, which is formed between parked vehicles or other obstacles.

Different devices and systems have therefore been provided for making things easier for the driver of a vehicle when parking. Specifically, so-called ParkPilots for detecting the distance of objects delimiting the parking space particularly in the rear, but also in the front region of the vehicle (PDC—park distance control, PAS—parking aid system) were suggested, in addition to systems for finding and measuring parking spaces (PSM=parking space measurement), as well as semi-autonomous or fully autonomous parking assistants. These systems utilize distance sensors operating in a contactless manner and preferably are realized by ultrasonic sensors, but also, for example, by infrared sensors, lidar sensors, radar sensors or similar sensors, with whose aid the presence of objects is detectable and/or the distance to objects is able to be measured in a contactless manner.

For example, a method and system for assisting the driver in determining suitable parking spaces using parking space measurements are known from published German patent document DE 103 20 723 A1. To begin with, distance sensors pointing to the side detect a first stationary obstacle when passing a potential parking space; then an at least essentially obstacle-free parking space is detected along a certain travel path recorded by a path sensor, and subsequently a second stationary obstacle is recorded. The length and/or depth of the space measured just then and/or information derived therefrom as to whether the vehicle will fit into this space between the obstacles may then be output to the driver. The measuring-interval rate or the sampling rate of the distance sensors is a function of the vehicle speed such that it rises with increasing speed. In addition, the distance sensors required for measuring the parking space may also be utilized for a parking-aid function (ParkPilot) in order to detect obstacles situated directly in front of or behind the vehicle.

In a ParkPilot system, the distances are measured between the own vehicle and objects located in front of or behind it. Distance sensors situated in the front or rear bumper of the vehicle are generally employed for this purpose. Likewise using special methods, the measured distance information is then utilized to calculate the distance between the bumper of the vehicle and other objects or vehicles located in the vicinity. The driver receives corresponding acoustic or optical information indicating the calculated or measured distance and possibly a separate warning as soon as the distance between his vehicle and other obstacles drops below a critical value.

Especially sensors mounted on the sides of the vehicle are frequently utilized both for the parking space measurement function and for the ParkPilot system. However, the systems and functions make different demands on the operation of the sensor system. For example, measuring a parking space requires the data or measuring rate of the laterally mounted sensors to be as high as possible. For the ParkPilot system, on the other hand, all sensors, i.e., both the sensors mounted on the sides and the sensors mounted in the front or rear bumper of the vehicle, must be controlled as uniformly as possible, which, however, reduces the maximum measuring rate in an effort to prevent cross-influencing or interference of the sensors. The simultaneous operation of both systems or functions for which the distance sensors are used for dual purposes is therefore impossible because in an active parking space measurement, the high measuring rate of the outer sensors prevents a reliable operation of the ParkPilot, and in an active ParkPilot, the measuring rate of the outer sensors is insufficient for a reliable parking space measurement.

From published German patent document DE 102 06 764 A1, a combined parking aid system is known, in which two measuring modes are provided for the distance sensors mounted on the sides of the vehicle. Different measuring methods, which differ in the frequency at which measuring signals are emitted, are used for searching for a suitable parking space or for measuring a parking space on the one hand, and for determining the distance on the other. When searching for a suitable parking space, for instance, the distance sensors on the side are operated at a high frequency at which a signal is emitted preferably every 20 to 40 ms. In the subsequent distance measurement for warning of looming collisions, not only the side sensors but also the sensors disposed in the front and rear are operated. The transmit sequence of the side sensors is reduced to a signal emission approximately every 120 to 240 ms. The switch between these two modes preferably occurs automatically such that, once a sufficiently large parking space has been detected, a switch is made from the parking space measurement mode into the distance warning mode.

From published German patent document DE 101 47 443 A1, an environment-monitoring device having a plurality of distance sensors for a motor vehicle is known, in which a plurality of measuring programs of the sensors can be implemented for different applications either simultaneously or at a time offset. Each sensor is triggered in a suitable operating mode and can thus be used as parking aid, e.g., for distance warning, or for measuring parking spaces, for example. A control unit specifies as a function of the desired monitoring which sensor is to supply data in which operating mode and at which frequency, it also being possible to include vehicle data such as the vehicle speed. The activation of a particular function may depend on a vehicle state, e.g., the vehicle speed or the engagement of the reverse gear, or alternatively also on a manual activation via an operating unit.

From published German patent document DE 102 16 346 A1, a method of the type mentioned in the introduction is known for operating a parking aid system for a motor vehicle, in which a plurality of distance sensors is used in two different measuring modes as ParkPilot for warning of imminent collisions during parking on the one hand, and for measuring parking spaces on the other. To allow both functions to be implemented simultaneously, the sensors are operated in a manner that continually switches back and forth between the two modes, the switching frequency possibly being relatively high. Also, depending on the vehicle speed when passing a parking space, it is possible to perform the measurements using a distance sensor detecting the side region of the vehicle at different time intervals. However, constantly switching back and forth between the two modes causes disadvantageous losses in time since a different sensor characteristic must be loaded in each change, which may require approximately 100 ms in each case. During this loading time, the system is unable to perform distance measurements, so that an alternating operation of the functions of ParkPilot and parking space measurement or parking space localization with a brief switchover of the characteristic curves is not possible. The resulting data rates would then be reduced so considerably that both the required rapid response of the ParkPilot function and the required precision of the parking-space measurement or the parking-space localization function could no longer be achieved. This already applies to vehicle speeds above approx. 2 km/h.

### BRIEF SUMMARY OF THE INVENTION

It is an object of the present invention to provide an improved method of the type mentioned in the introduction, which makes it possible to optimize the switch between the two functions of parking space measurement and ParkPilot in a simple manner.

The idea on which the present invention is based is that the distance sensors in both modes are temporally controlled in such a way that they are activated at different transmit sequences, an automatic switchover between the different transmit sequences of the two modes taking place as a function of the movement of the vehicle.

An essential basic idea of the present invention is that the two measuring modes no longer differ by different sensor characteristic curves, which must be loaded in alternation at a loss in time and thus with a reduction of the achievable measuring precision, but merely by a different sequence of the measurements of all distance sensors used in the particular measuring mode, the characteristic or the sensor characteristic curve of each individual distance sensor remaining constant.

An essential advantage of the method according to the present invention is that a switch between the two measuring modes does not cause any loss in time. Also, a switch between the two modes takes place automatically as a function of certain moving states, which in turn has the advantage that an activation of a function does not require any prior deactivation of the respective other function.

If, for example, the parking space measurement is activated and a situation arises in which the driver requires the assistance of the ParkPilot, then the driver need neither actively switch over, nor will there be a transition phase in an automatic switch to the ParkPilot mode during which no distance measurements are carried out. The same applies in the reverse case, if the parking space measurement function is reactivated for a new parking space search, so that in this case as well, the driver is conveniently not required to switch over and need not be afraid of disadvantageous measuring inaccuracies in the transition between the two measuring modes either. This in turn increases the acceptance of parking space measurements and the ParkPilot by the driver of the vehicle, in particular also against the backdrop of a greatly increasing number of electronic components and driver assistance systems in the vehicle.

For instance, it is particularly advantageous if the distance sensors are able to be operated in a third mode in which they are activated according to a transmit sequence in which both the measuring of parking spaces and the parking assistance function for warning of looming collisions are carried out simultaneously. The activation of this third mode advantageously also is a function of specific moving states of the vehicle; here, too, no reloading of sensor characteristic curves is required. This third mode is defined only by a specific transmit sequence of the sensors available for both functions. The parallel operation of both functions is thereby possible at optimum measuring accuracy.

The movement states on which the switchover between the different transmit sequences of the different measuring modes may depend may include the vehicle speed, in particular, as is also the case in the previously cited related art. For instance, it is particularly advantageous if at a higher speed the transmit sequence is controlled in such a way that the distance sensors sensing the side region of the vehicle transmit a measuring signal more frequently during a complete measuring cycle than would be the case at lower speeds.

Alternatively or additionally, the switchover between the different transmit sequences of the different measuring modes may take place as a function of the vehicle acceleration, so that at specific decelerations, for instance, a transmit sequence is selected that is optimized for the Park Pilot function, and/or at specific accelerations of the vehicle, the transmit sequence of the distance sensors is optimized for the parking space measurement, in particular.

However, it is especially advantageous if the switchover takes place as a function of the travel path which the vehicle travels during the cycle time of a transmit sequence or a specific number of transmit sequences as recorded by the path sensor. The effective cycle time of a side sensor may also be considered as cycle time of a transmit sequence. This switchover preferably takes place in such a way that the traveled distance always lies below a specified or specifiable limit. In this way the transmit sequence or the measuring mode is no longer dependent only on parameters of the vehicle movement such as the vehicle speed and/or the vehicle acceleration, but the transmit sequence or the measuring mode is a function both of a vehicle movement, i.e., the driven distance, and the environment of the vehicle. It is of particular importance in this context that the measurement repetition usually taking place in order to verify a distance measurement, which is referred to as so-called “double shot”, is considerably affected by the environment. In this method for verifying a measuring result, a measured distance is processed further only if its echo value is confirmed by the immediately following second measurement. This method constitutes a first filtering step, by which the stability and reliability of the measured distances is increased significantly. Since the path traveled by the vehicle during the cycle time of a transmit sequence likewise increases when the number of double shots rises, the control of the distance sensors in a specific transmit sequence across this traveled path is also indirectly a function of the environment of the vehicle.

According to an embodiment of the present invention, this double-shot control of at least individual distance sensors takes place only if the obstacle is determined at a distance that is smaller than a specified limit distance or a limit distance that the user is able to specify. Because the implementation of double shots affects the sampling width of the side distance sensors and thus has a negative effect on the precision of the parking-space measurement function, it is especially advantageous if the frequency of double shots when passing a parking space is as low as possible, especially at higher speeds. The proposed specification of a limit distance makes it possible for double shots to be triggered by the side sensors when passing a parking space only when the distance between the passing vehicle and the parked vehicles is lower than the specified limit distance. The passing distance with respect to side obstacles usually gets larger with increasing vehicle speed because most drivers tend to keep a greater distance to the parked vehicles at faster driving speeds. At greater speeds, this then automatically leads to an increase in the sampling rate of the outer sensors and thus to an improved detection of the parked vehicles or the parking spaces possibly situated in-between.

In this context it is proposed that the limit distance preferably lies between 0.8 and 1.2 meters or is adjustable to these values, a distance of approximately 1 meter being advantageous.

In addition, it is especially advantageous if only the outer distance sensors, which detect the region to the side of the vehicle, are controlled according to the aforementioned restriction with regard to the limit distance, since the side sensors, in particular, are of special importance in the parking space measurement. However, the distance sensors disposed in the front or rear bumper of the vehicle may be triggered in the aforementioned manner as well.

Furthermore, a corresponding driver assistance system, which is suitable for implementing the method of the type previously described, is also a subject matter of the present invention. Such a system includes a plurality of distance sensors, each sensing the near region at least regionally, at least one path sensor, and at least one control unit connected to the path sensor and the distance sensors, by which the distance sensors are able to be activated as a function of the signals provided by the path sensor, or as a function of variables derivable therefrom, in different transmit sequences.

Furthermore, the present invention relates to a vehicle equipped with such a system.

### BRIEF DESCRIPTION OF THE DRAWING

FIG. 1 shows a schematic illustration of a motor vehicle equipped with a system according to the present invention.

### DETAILED DESCRIPTION OF THE INVENTION

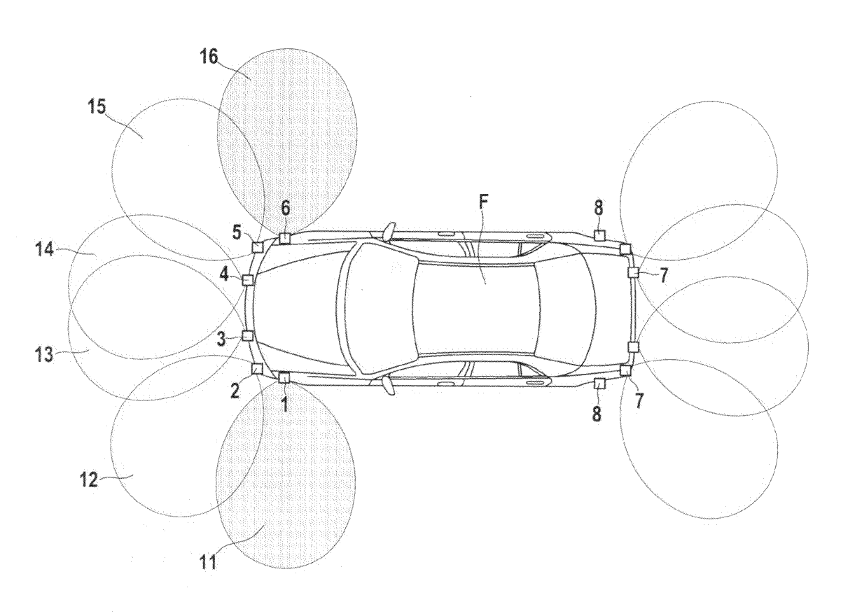

FIG. 1 shows a motor vehicle F, which is equipped with six distance sensors both in the front and in the rear, which operate according to the ultrasound principle. The four distance sensors 2, 3, 4 and 5 disposed in the front bumper of vehicle F sense the near range in front of vehicle F, while the two distance sensors 1 and 6 disposed in the front region of vehicle F to the side sense the near range situated to the left and right of the vehicle. The lobe-shaped detection ranges 11-16 of these six distance sensors 1-6 are illustrated schematically. Although the method according to the present invention may also be implemented using a different number of distance sensors and also using the distance sensors 7 disposed in the rear bumper of vehicle F, and distance sensors 8 disposed in the rear region of vehicle F to the side, it will be described in the following text for front sensors 1 through 6 merely by way of example.

The system based on ultrasound is used both for parking space measurements and for implementing the ParkPilot function. Detection ranges 11 and 16 of outer sensors 1 and 6, which are used for measuring the parking space, are shown in darker shade than detection ranges 12-15 of forward pointing sensors 2 through 5, which are used exclusively for the ParkPilot function. In order to ensure an optimal ParkPilot functionality, outer sensors 1 and 6 are used both for the parking space measurement and for the ParkPilot function.

Sensors 1 through 8 operate according to the pulse-echo principle, in which an ultrasonic pulse is emitted and reflected by objects present in the vicinity of vehicle F or in the vicinity of sensors 1-6. For each sensor 1 through 6, or for each sensor pair, the distance to the objects is calculated in the manner known as such based on the sound propagation time that elapses between the emission of the sound pulse and the arrival of the reflected echo on the sensor diaphragm.

If the ParkPilot function is activated, ultrasonic pulses are not emitted by all sensors 1 through 6 simultaneously, but rather in a time-staggered manner relative to each other. Which sensors 1 through 6 transmit at what time is specified in so-called transmit sequences. A transmit sequence is made up of a plurality of sequentially processed measuring cycles. In the following cycle having four sequential cycles I-IV illustrated by way of example, only certain sensors are transmitting simultaneously:

### I. Nos. 1 and 5

### II. Nos. 2 and 6

### III. No. 4

### IV. No. 3.

The reflected echoes are then detected, in a manner known per se, both by the particular sensors that emitted a pulse, and by the adjacent sensors (referred to as cross-echo detection). With the aid of this method, the cross echoes, in particular, are able to be assigned to the correct sensors 1 through 6, so that it is advantageously possible to determine not only the direct distance from the bumper to the objects, but their lateral position with respect to the bumper as well.

However, the demands placed on a system for parking space measurement require a distance measurement or sampling of the lateral environment of the vehicle as frequently as possible. This means that laterally mounted sensors 1 or 6 (depending on the selected side) are to transmit and receive as often as possible. It is obvious that compliance with this demand becomes more and more important the faster vehicle F is driving. Transferred to the aforementioned transmit sequence, this means that the selected sensor is to transmit and receive in every cycle. This demand is incompatible with the method used in the ParkPilot function, since outer sensor 1 or 6, for example, emits an ultrasonic pulse only in every fourth cycle I or II in the above-mentioned transmit sequence.

According to the present invention, the transmit sequence is therefore varied as a function of the movement, here, for instance, the speed of vehicle F, to the effect that an automatic switchover of the functions is able to take place and both functions may even be activated simultaneously within certain limits. To this end, one examines the sampling length associated with the parking space measurement, i.e., the traveled path between two sequential ultrasound measurements of a side sensor 1 or 6: If one assumes a sampling length of maximally 10 cm, for example, and a cycle time of 25 ms, then a vehicle speed of 4.0 m/s or 14.4 km/h is the result. For a cycle time of 100 ms (this corresponds to the effective cycle time of a lateral sensor 1 or 6 in the ParkPilot mode) a speed of 1.0 m/s or 3.6 km/h is therefore obtained. The result is as follows:

In a lower speed range below approximately 3.6 km/h, for example, both the ParkPilot function and the parking space measurement may take place in parallel without any restriction of functions, since for one, the transmit sequence required for the ParkPilot and also the sampling length required for the parking space measurement are able to be observed.

In a medium speed range between approximately 3.6 km/h and 14.4 km/h, for example, the transmit sequence is varied in such a way that both functionalities are realized with the fewest restrictions possible in terms of precision and response time. The transmit sequence may then take the following form:

### I. Nos. 1 and 5

### II. Nos. 2 and 6

### III. Nos. 1 and 4

### IV. Nos. 3 and 6

In an upper speed range above approximately 14.4 km/h, for instance, the system is able to reliably perform the parking-space measurement function only if the maximum precision of the parking space measurement is maintained, which is a function of the speed. According to the present invention, it is therefore provided to set the transmit sequence, which is controlled by the measuring program, as a function of the speed and according to the afore-described conclusions, thereby realizing a parallel operation of ParkPilot and parking space measurement only in the lower and medium speed range.

Preferably, the critical speed range between 3.6 km/h and 14.4 km/h may be subdivided further, if required, in that, for example, the transmit sequence is set such that the parallel operation below 9.0 km/h is optimized with regard to the ParkPilot function (at a simultaneous slight reduction of the precision of the parking space measurement), and above 9.0 km/h, it is optimized with regard to the maximum precision of the parking space measurement (while simultaneously representing a ParkPilot basic functionality, e.g., with an increased response time).

1-10. (canceled)

11. A method for operating a parking aid system for a vehicle having a plurality of distance sensors each sensing in the immediate adjacent region of the vehicle and having at least one path sensor sensing a path traveled by the vehicle, the method comprising:
operating the distance sensors in a first operating mode for measurement of a parking space, wherein at least one of the length and width of the parking space is determined in the first operating mode from measured values produced by the distance sensors while the vehicle passes the parking space; and
operating the distance sensors in at least a second mode, wherein the distance sensors are used as parking aid in the second mode in order to avoid collisions;
wherein the distance sensors are temporally activated using different transmit sequences in the first and second operating modes, and wherein a switch between the different transmit sequences is implemented as a function of the movement of the vehicle.

12. The method as recited in claim 11, further comprising:
operating the distance sensors in a third operating mode, wherein the distance sensors are activated at a selected transmit sequence in which measurement of the parking space and warning of an impending collision are implemented simultaneously in the third operating mode.

13. The method as recited in claim 11, wherein the switchover takes place as a function of the vehicle speed.

14. The method as recited in claim 11, wherein the switchover takes place as a function of the vehicle acceleration.

15. The method as recited in claim 11, wherein the switchover takes place as a function of the distance traveled by the vehicle during a cycle time of a transmit sequence as detected by the path sensor.

16. The method as recited in claim 11, wherein selected sensors among the distance sensors are controlled in such a way that the selected sensors are activated a second time immediately after an obstacle has been detected, wherein the second activation of the selected sensors take place only if the obstacle is detected at a distance that is smaller than a specified limit distance.

17. The method as recited in claim 16, wherein the limit distance is between 0.8 and 1.2 meters.

18. The method as recited in claim 16, wherein only outer distance sensors which sense lateral regions of the vehicle are selected as the selected sensors.

19. A parking aid system for a vehicle, comprising:
a plurality of distance sensors each configured to sense in the immediate adjacent region of the vehicle;
at least one path sensor sensing a path traveled by the vehicle; and
a control unit connected to the distance sensors and the path sensor, wherein the control unit is configured to control the operation of the distance sensors in the following manner:
operate the distance sensors in a first operating mode for measurement of a parking space, wherein at least one of the length and width of the parking space is determined in the first operating mode from measured values produced by the distance sensors while the vehicle passes the parking space; and
operate the distance sensors in at least a second mode, wherein the distance sensors are used as parking aid in the second mode in order to avoid collisions;
wherein the distance sensors are temporally activated using different transmit sequences in the first and second operating modes, and wherein a switch between the different transmit sequences is implemented as a function of the movement of the vehicle.
